(19) United States
(12) Patent Application Publication
(10) Pub. No.: US 2019/0255890 A1
(43) Pub. Date: Aug. 22, 2019

(54) PNEUMATIC TIRE

(71) Applicant: Toyo Tire Corporation, Itami-shi (JP)

(72) Inventor: Jiro Taniguchi, Itami-shi (JP)

(73) Assignee: Toyo Tire Corporation, Itami-shi, Hyogo (JP)

(21) Appl. No.: 16/267,863

(22) Filed: Feb. 5, 2019

(30) Foreign Application Priority Data
Feb. 21, 2018 (JP) 2018-028820

(51) Int. Cl. B60C 11/12; B60C 11/01; B60C 11/03

(52) U.S. Cl. CPC B60C 11/1236; B60C 11/01; B60C 2200/14; B60C 11/0309; B60C 11/1204

(57) ABSTRACT

The present invention is characterized that a first block 20 in a shape of having a projected section 22 that extends in a tire circumferential direction and a second block 30 in a different shape from the first block 20 are alternately aligned in the tire circumferential direction to forma block row, that two of the block rows are famed, and that the two second blocks 30 are arranged on both sides in a tire width direction of the projected section 22 of the first block 20.

### INCORPORATION BY REFERENCE

The present application benefits by the priority right claimed in Japanese Patent Application No. 2018-028820 filed on Feb. 21, 2018 on the basis of Japanese Patent Application No. 2018-028820. Japanese Patent Application No. 2018-028820 is incorporated herein by reference in its entirety.

### TECHNICAL FIELD

The present invention relates to a pneumatic tire.

### BACKGROUND ART

As disclosed in Patent Documents 1 to 3, a pneumatic tire in which polygonal blocks are aligned in a tread has been known. In such a pneumatic tire, it has been known that the polygonal blocks exert a traction property in a tire circumferential direction and a tire width direction.

In order for the pneumatic tire to exert the traction property in further multiple directions, and in order for the pneumatic tire to exert the further significant traction property, it is advantageous that each of the blocks has a large number of ends (sides) extending in different directions. In particular, in order to improve the traction property in the tire width direction, which is often insufficient, it is advantageous to form a projected section, which extends in the tire circumferential direction, in each of the blocks.

In addition, in order for the pneumatic tire to exert the significant traction property in the multiple directions, it is advantageous to provide two or more types of the blocks in different shapes in a central region of the tread in the width direction.

Patent Document 1: Japanese Patent No. 6097263

Patent Document 2: Japanese Patent No. 6114731

Patent Document 3: Japanese Patent No. 6154834

### DISCLOSURE OF THE INVENTION

### Problems that the Invention is to Solve

By the way, the projected section, which is formed in each of the blocks and extends in the tire circumferential direction, has a small area and low rigidity. Thus, there is a problem that the projected section is easily worn when the pneumatic tire rotates on a road surface and the projected section in each of the blocks kicks the road surface.

In view of the above, the present invention has a purpose of providing a pneumatic tire which exerts a favorable traction property and in which local wear of a block is less likely to occur.

### Means for Solving the Problems

A pneumatic tire according to an embodiment is characterized that a first block in a shape of having a projected section that extends in a tire circumferential direction and a second block in a different shape from the first block are alternately aligned in the tire circumferential direction to form a block row, that two of the block rows are formed, and that the two second blocks are arranged on both sides in a tire width direction of the projected section of the first block.

### Advantage of the Invention

Just as described, since the first block in the shape of having the projected section that extends in the tire circumferential direction and the second block in the different shape from the first block are alternately aligned in the tire circumferential direction, a traction property is favorably exerted. In addition, since the two second blocks are arranged on both of the sides in the tire width direction of the projected section of the first block, local wear of the projected section is less likely to occur.

### BRIEF DESCRIPTION OF THE DRAWINGS

FIG. 1 It depicts a tread pattern of a pneumatic tire according to an embodiment.

FIG. 2 It is a perspective view of the tread according to the embodiment.

FIG. 3 It is an enlarged view of a portion near a first bent groove in FIG. 1.

FIG. 4 It is a cross-sectional view that is taken along A-A in FIG. 1. Upper surfaces of blocks in FIG. 4 are ground contact surfaces.

FIG. 5 It is a cross-sectional view that is taken along B-B in FIG. 1. The upper surfaces of the blocks in FIG. 5 are the ground contact surfaces.

FIG. 6 It is a cross-sectional view that is taken along C-C in FIG. 1. The upper surfaces of the blocks in FIG. 6 are the ground contact surfaces.

FIG. 7 It is a cross-sectional view that is taken along D-D in FIG. 1. The upper surface of the block in FIG. 7 is the ground contact surface.

### EMBODIMENT

A pneumatic tire according to an embodiment will be described on the basis of the drawings. Note that features of the pneumatic tire, which will be described below, are features in an unloaded state of the pneumatic tire that is attached to a legitimate rim and is filled with air to have a legitimate inner pressure unless otherwise noted. Here, the legitimate rim is specified as the “Standard Rim” in JATMA standards, the “Design Rim” in TRA standards, or the “Measuring Rim” in ETRTO standards. In addition, the legitimate inner pressure is specified as the “Maximum inflation pressure” in the JATMA standards, a maximum value set in the “TIRE LOAD LIMITS AT VARIOUS COLD INFLATION PRESSURES” in the TRA standards, or the “INFLATION PRESSURE” in the ETRTO standards.

In the invention of the present application, a sipe is a narrow groove, and more specifically, is a groove, an opening of which to a ground contact surface is closed under a condition that the pneumatic tire, which is attached to the legitimate rim and is filled with the air to have the legitimate inner pressure, contacts the ground and a legitimate load acts thereon. Here, the legitimate load is specified as the “Maximum load capacity” in the JATMA standards, a maximum value set in the “TIRE LOAD LIMITS AT VARIOUS COLD INFLATION PRESSURES” in the TRA standards, or the “LOAD CAPACITY” in the ETRTO standards. In the case where simply the “groove” is referred in the following description, “the groove” means a groove that has a greater width than the sipe and has an opening to the ground contact surface that is not closed even under the above-described condition.

In the following description, the ground contact surface is a surface of the pneumatic tire that comes into contact with a road surface when the legitimate load acts on the pneumatic tire, which is attached to the legitimate rim and is filled with the air to have the legitimate inner pressure.

In the invention of the present application, a block is a land section that is partitioned and formed by the plural grooves. Each of the blocks has the ground contact surface with the road surface.

The pneumatic tire according to the embodiment is mounted on a vehicle such as a lightweight truck. An overview of a cross-sectional structure of the pneumatic tire according to the embodiment will be described below. A bead is provided on each side in a tire width direction, a carcass ply is folded from an inner side to an outer side in the tire width direction to wrap the beads and defines a framework of the pneumatic tire. A belt is provided on an outer side of the carcass ply in a tire radial direction, and a tread having the ground contact surface is provided on an outer side of the belt in the tire radial direction. A sidewall is provided on each side of the carcass ply in the tire width direction. In addition to these members, plural members that are required to satisfy functions of the tire are provided.

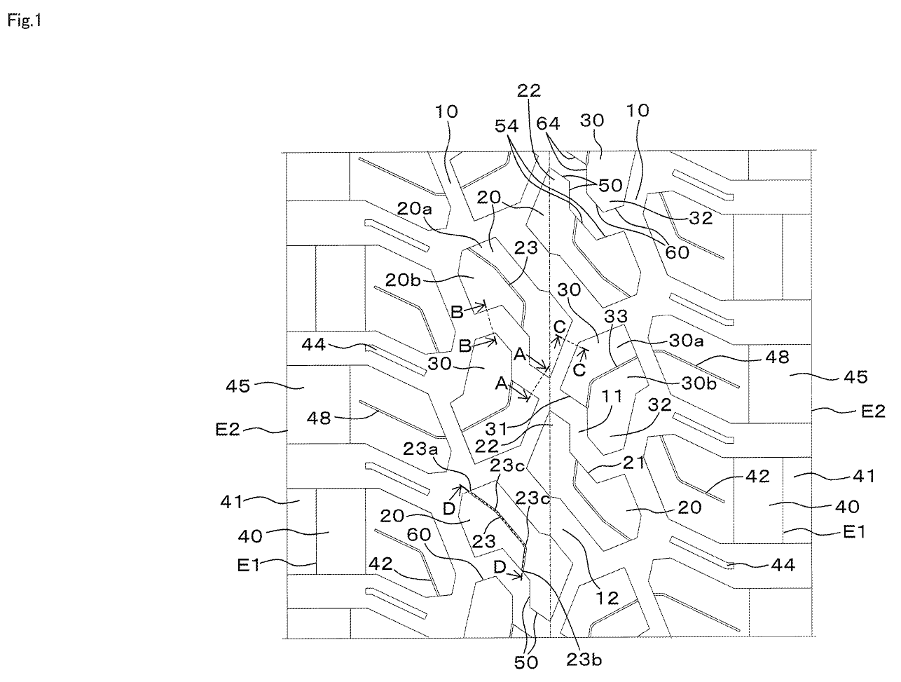

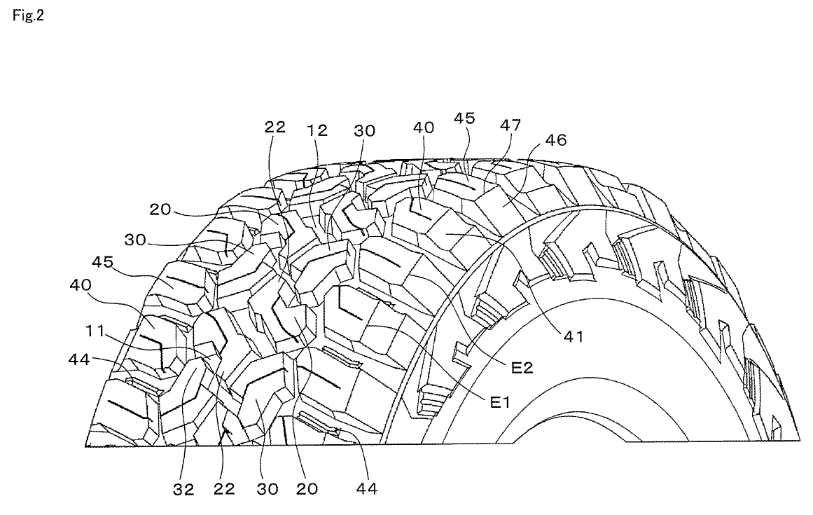

The tread is formed with a tread pattern depicted in FIG. 1 and FIG. 2. The tread is formed with two tire circumferential grooves 10, each of which extends in a tire circumferential direction while being bent. The tread is also formed with: a center region that is sandwiched between the two tire circumferential grooves 10; and a shoulder region on an outer side in the tire width direction of each of the tire circumferential grooves 10.

The center region is formed with two block rows, in each of which first blocks 20 and second blocks 30 in different shapes from each other are alternately aligned in the tire circumferential direction. The shoulder region on each of the sides in the tire width direction is formed with a block row, in which third blocks 40 and fourth blocks 45 in different shapes from each other are alternately aligned in the tire circumferential direction. Thus, this tread is formed with the four block rows.

When seen from a tire outer diameter side, each of the first blocks 20 and the second blocks 30 in the center region has a polygonal shape with plural sides. The first block 20 is longer than the second block 30 in the tire width direction. In FIG. 1 to FIG. 3, the first block 20 has the polygonal shape with 11 sides, and the second block 30 has the polygonal shape with 9 sides. However, each of the blocks may have a different shape.

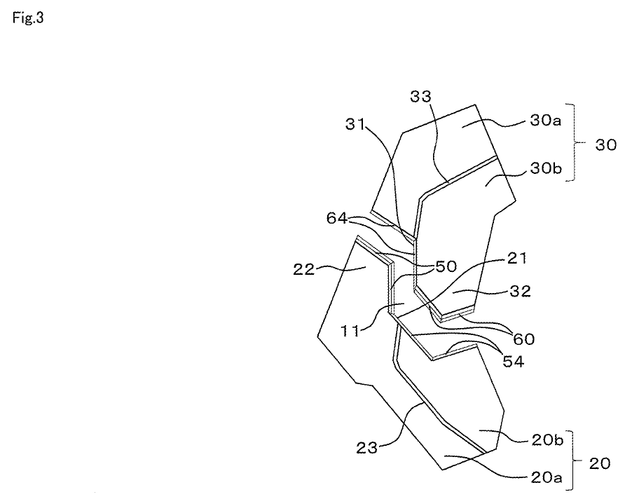

As depicted in FIG. 1 and FIG. 3, the first block 20 has a first cutout section 21 that has a shape of being cut out when seen from the tire outer diameter side and that is located near a central portion of the first block 20 in a longitudinal direction. Due to presence of the first cutout section 21, the first block 20 is formed with a hook-like portion when seen from the tire outer diameter side. A tip portion of the hook is a first projected section 22 that extends in the tire circumferential direction. The first projected section 22 extends toward the second block 30.

As depicted in FIG. 1 and FIG. 3, the second block 30 has a second cutout section 31 that has a shape of being cut out when seen from the tire outer diameter side and that is located in a portion of the second block 30 opposing the first projected section 22 of the first block 20. Due to presence of the second cutout section 31, the second block 30 is formed with a second projected section 32 that extends in the tire circumferential direction. The second projected section 32 extends toward the first cutout section 21 of the first block 20.

The first block 20 and the second block 30 are arranged such that the first projected section 22 and the second projected section 32 respectively approach the cutout sections 31, 21 of the other blocks and overlap each other in the tire width direction. Accordingly, the first projected section 22 of the first block 20 and the second cutout section 31 of the second block 30 oppose each other via a groove, and the first cutout section 21 of the first block 20 and the second projected section 32 of the second block 30 oppose each other via the groove.

The groove that runs from a position between the first projected section 22 and the second cutout section 31 to a position between the first cutout section 21 and the second projected section 32 is a first bent groove 11 that has three bent sections when seen from the tire outer diameter side. The three bent sections of the first bent groove 11 define the shapes of the first projected section 22, the second cutout section 31, the first cutout section 21, and the second projected section 32.

In addition, the first projected section 22 of the first block 20 is located between the two second blocks 30 (that is, the second blocks 30 in the two block rows of the center region). Thus, the two second blocks 30 are arranged on both sides in the tire width direction of the first projected section 22 of the first block 20.

In the center region, the first block 20 in the right block row and the first block 20 in the left block row oppose each other via a second bent groove 12 having a bent section. The second bent groove 12 as a whole extends in an inclined direction with respect to the tire circumferential direction and the tire radial direction. The first cutout section 21 of the one first block 20 and a portion on an opposite side of the first cutout section 21 of the other first block 20 face the second bent groove 12. A distance between the first blocks 20 is longer than a distance between the other blocks in the center region. That is, the second bent groove 12 has a greater width than any of the other grooves, each of which divides the blocks, in the center region. The width of the second bent groove 12 is greater than width of the tire circumferential groove 10.

The first block 20 and the second block 30 are designed to have substantially the equal area (precisely, an area of the ground contact surface of each of the blocks). As a preferred mode, a difference in the area between the first block 20 and the second block 30 falls within 15% of one of the areas. As a further preferred mode, the difference in the area between the first block 20 and the second block 30 falls within 15% of smaller one of the areas.

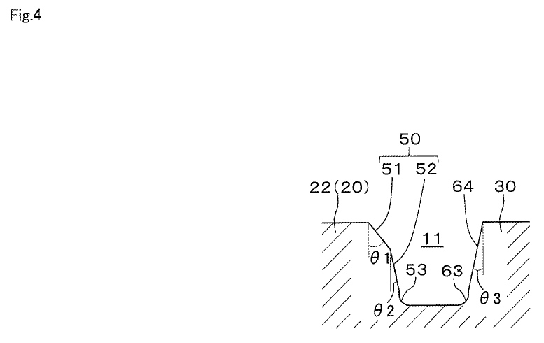

As depicted in FIG. 1, FIG. 3, and FIG. 4, in the first projected section 22 of the first block 20, a two-step tapered section 50 is formed in an end (a side) that opposes the second block 30. As depicted in FIG. 4, the two-step tapered section 50 includes: a first tapered surface 51 that is coupled to the ground contact surface of the first block 20 and extends toward a groove bottom side (that is, a bottom side of the first bent groove 11); and a second tapered surface 52 that is coupled to the first tapered surface 51 and further extends toward the groove bottom side. That is, the two-step tapered section 50 includes the first tapered surface 51 on the tire outer diameter side and the second tapered surface 52 on a tire inner diameter side.

Each of the first tapered surface 51 and the second tapered surface 52 is inclined with respect to the tire radial direction. An inclination angle θ1 of the first tapered surface 51 with respect to the tire radial direction is larger than an inclination angle θ2 of the second tapered surface 52 with respect to the tire radial direction. For example, θ1 is equal to or larger than 10° and equal to or smaller than 25°, and θ2 is equal to or larger than 3° and equal to or smaller than 8°.

On the groove bottom side of the second tapered surface 52, an R surface 53 that couples the second tapered surface 52 and the bottom of the first bent groove 11 is formed. Note that a wall surface that extends in the tire radial direction may be formed between the second tapered surface 52 and the R surface 53.

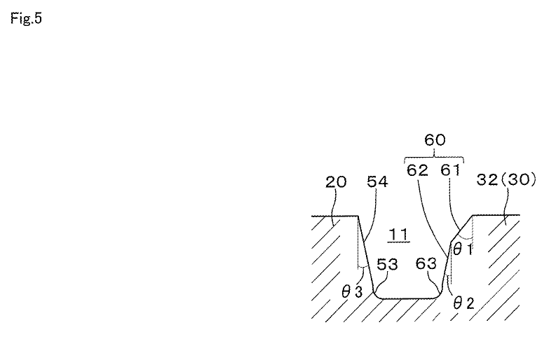

As depicted in FIG. 1, FIG. 3, and FIG. 5, a third tapered surface 54 that is coupled to the ground contact surface of the first block 20 and extends toward the groove bottom side is formed at a position that is adjacent to the two-step tapered section 50 at the end of the first block 20 on the first bent groove 11 side (that is, a position opposing the second projected section 32 of the second block 30). An inclination angle θ3 of the third tapered surface 54 with respect to the tire radial direction is smaller than the inclination angle θ1 of the first tapered surface 51 with respect to the tire radial direction. For example, θ3 is equal to or larger than 3° and equal to or smaller than 8°.

On the groove bottom side of the third tapered surface 54, the R surface 53 that couples the third tapered surface 54 and the bottom of the first bent groove 11 is famed. Note that the wall surface that extends in the tire radial direction may be famed between the third tapered surface 54 and the R surface 53.

As depicted in FIG. 1, FIG. 3, and FIG. 5, in the second projected section 32 of the second block 30, a two-step tapered section 60 that is similar to the two-step tapered section 50 is formed in an end (a side) that opposes the first block 20. More specifically, the two-step tapered section 60 includes: a first tapered surface 61 that is coupled to the ground contact surface of the second block 30 and extends toward the groove bottom side (that is, the bottom side of the first bent groove 11); and a second tapered surface 62 that is coupled to the first tapered surface 61 and further extends toward the groove bottom side. That is, the two-step tapered section 60 includes the first tapered surface 61 on the tire outer diameter side and the second tapered surface 62 on the tire inner diameter side.

Similar to the case of the two-step tapered section 50, each of the first tapered surface 61 and the second tapered surface 62 is inclined with respect to the tire radial direction. The inclination angle θ1 of the first tapered surface 61 with respect to the tire radial direction is larger than the inclination angle θ2 of the second tapered surface 62 with respect to the tire radial direction. For example, θ1 is equal to or larger than 10° and equal to or smaller than 25°, and θ2 is equal to or larger than 3° and equal to or smaller than 8°.

On the groove bottom side of the second tapered surface 62, an R surface 63 that couples the second tapered surface 62 and the bottom of the first bent groove 11 is formed. Note that a wall surface that extends in the tire radial direction may be formed between the second tapered surface 62 and the R surface 63.

As depicted in FIG. 1, FIG. 3, and FIG. 4, a third tapered surface 64, which is similar to the third tapered surface 54, is formed at a position that is adjacent to the two-step tapered section 60 at the end of the second block 30 on the first bent groove 11 side (that is, a position opposing the first projected section 22 of the first block 20). That is, the third tapered surface 64 that is coupled to the ground contact surface of the second block 30 and that extends toward the groove bottom side is formed. The inclination angle θ3 of the third tapered surface 64 with respect to the tire radial direction is smaller than the inclination angle θ1 of the first tapered surface 61 with respect to the tire radial direction. For example, θ3 is equal to or larger than 3° and equal to or smaller than 8°.

On the groove bottom side of the third tapered surface 64, the R surface 63 that couples the third tapered surface 64 and the bottom of the first bent groove 11 is famed. Note that the wall surface that extends in the tire radial direction may be famed between the third tapered surface 64 and the R surface 63.

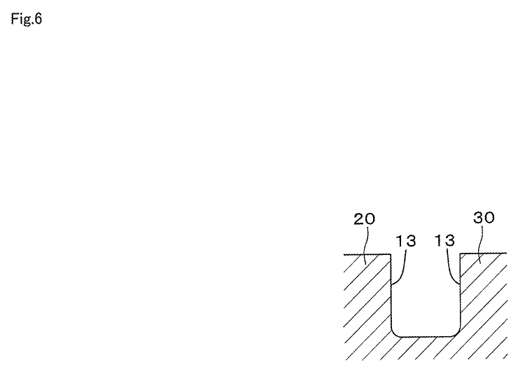

As depicted in FIG. 6, a wall surface 13 that extends in the tire radial direction is provided as a side wall of a portion in each of the ends (the sides) of the first block 20 and the second block 30 other than the ends formed with the two-step tapered sections 50, 60 and the third tapered surfaces 54, 64.

As depicted in FIG. 1 and FIG. 3, the first block 20 and the second block 30 are respectively famed with sipes 23, 33. The first block 20 is divided into two block pieces 20a, 20b by the sipe 23. The sipe 23 is provided such that the block pieces 20a, 20b are divided to have a substantially equal area (precisely, an area of the ground contact surface of each of the block pieces). In a preferred mode, the area of each of the block pieces 20a, 20b is equal to or larger than 35% and equal to or smaller than 65% of the area of the first block 20.

Similarly, the second block 30 is divided into two block pieces 30a, 30b by the sipe 33. The sipe 33 is provided such that the block pieces 30a, 30b are divided to have a substantially equal area (precisely, an area of the ground contact surface of each of the block pieces). In a preferred mode, the area of each of the block pieces 30a, 30b is equal to or larger than 35% and equal to or smaller than 65% of the area of the second block 30.

One end of each of these sipes 23, 33 is opened to the tire circumferential groove 10, and the other end thereof is opened to the groove (for example, the first bent groove 11) that divides the first block 20 and the second block 30. Each of these sipes 23, 33 has a bent section that is bent when seen from the tire outer diameter side.

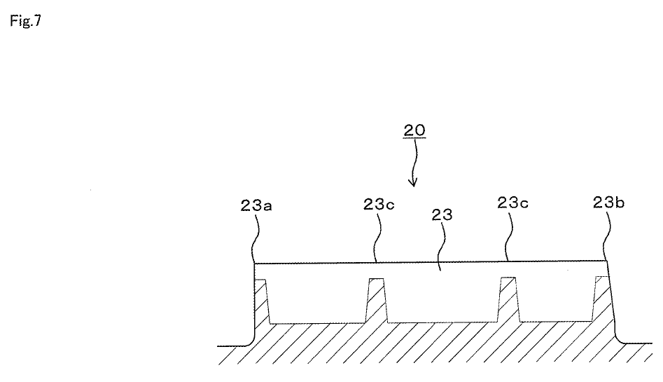

In each of these sipes 23, 33, at least one of the bent section and the end (that is, an opening end to the groove) is shallow. For example, as in the sipe 23 depicted in FIG. 7, the sipe may be famed to be shallow in both of ends 23a, 23b and a bent section 23c.

A depth of each of the sipes 23, 33 is preferably equal to or greater than 70% and equal to or less than 85% of a depth of the groove surrounding the first block 20 and the second block 30. However, in a shallow portion of each of the sipes 23, 33 as described above, the depth of each of the sipes 23, 33 is preferably equal to or greater than 15% and equal to or less than 25% of the depth of the groove surrounding the first block 20 and the second block 30. Note that the depth of the groove surrounding the first block 20 and the second block 30 is equal to or greater than 12 mm and equal to or less than 14 mm, for example.

As depicted in FIG. 1 and FIG. 2, when seen from the tire outer diameter side, each of the third blocks 40 and the fourth blocks 45 in the shoulder regions has the polygonal shape with plural sides.

As depicted in FIG. 2, a corner section 47 is formed in a portion on the outer side in the tire width direction of the fourth block 45 where the ground contact surface and a side wall 46 on the outer side in the tire width direction meet. Meanwhile, in a portion on the outer side in the tire width direction of the third block 40, a recessed section 41 is formed in such a shape that a portion corresponding to the corner section 47 of the fourth block 45 is bored. Due to presence of this recessed section 41, a ground contact end (an end of the ground contact surface on the outer side in the tire width direction) E1 of the third block 40 is located inward in the tire width direction from a ground contact end (an end of the ground contact surface on the outer side in the tire width direction) E2 of the fourth block 45. Thus, the third block 40 is shorter than the fourth block 45 in the tire width direction.

The third block 40, which is short in the tire width direction, is aligned with the first block 20, which is long in the tire width direction, in the tire width direction.

The third block 40 and the fourth block 45 are respectively formed with sipes 42, 48. One end of each of these sipes 42, 48 is opened to the tire circumferential groove 10, and the other end thereof is closed in the respective block. Each of these sipes 42, 48 has a bent section when seen from the tire outer diameter side. In each of these sipes 42, 48, at least one of an opening end to the tire circumferential groove 10 (that is, the end of the block) and the bent section may be shallow.

A projection 44 that is lower than the third block 40 and the fourth block 45 is formed on a groove bottom of a lateral groove that divides the third block 40 and the fourth block 45.

The pneumatic tire having the structure that has been described so far exhibits the following effects. The first blocks 20 and the second blocks 30 in the different shapes are alternately aligned in the tire circumferential direction to form the block rows, and two of such block rows are provided. Thus, the pneumatic tire can exert a superior traction property in multiple directions. In particular, since each of the first blocks 20 has the first projected section 22, which extends in the tire circumferential direction, the traction property in the tire width direction, which is often insufficient, can be exerted.

Furthermore, the two second blocks 30 are arranged on both of the sides in the tire width direction of the first projected section 22 of the first block 20. Thus, when the first projected section 22 kicks the road surface, the second blocks 30 on both of the sides always contact the ground. Accordingly, an excessive pressure is unlikely to be applied to the first projected section 22, and the first projected section 22 is unlikely to be slipped significantly on the road surface. As a result, local wear by which the first projected section 22 is significantly worn is less likely to occur.

Moreover, the first block 20 is longer than the second block 30 in the tire width direction, the third block 40 is shorter than the fourth block 45 in the tire width direction, and the first block 20 and the third block 40 are aligned in the tire width direction. Thus, a fluctuation in an area is made to be small.

Here, the fluctuation in the area means a fluctuation in a ground contact area in the tire circumferential direction at a kicking position or a depressing position at the time when the tread kicks the road surface or depresses the road surface. It can be regarded that the fluctuation in the area is reduced as lengths in the tire width direction of the surfaces (the ground contact surfaces) of the blocks become equalized in the tire circumferential direction. In addition, as the fluctuation in the area is reduced, effects such as noise suppression are exerted.

As described above, at a position where the first blocks 20, each of which is long in the tire width direction, are adjacent to each other, the width of the second bent groove 12, which is arranged between the two first blocks 20 in the manner to be inclined with respect to the tire width direction, is set to be large, and thus the distance between the first blocks 20 is set to be long. Such a structure also reduces the fluctuation in the area.

The first block 20 and the second block 30 are respectively formed with the sipes 23, 33, each of which penetrates the respective block. Accordingly, the sipes 23, 33 cancel slippage of the blocks 20, 30 on the road surface, and thus the local wear is suppressed. In addition, a ground contact pressure is uniformized in each of the blocks 20, 30.

Here, the first block 20 is divided by the sipe 23 into the two block pieces 20a, 20b. The area of each of the block pieces 20a, 20b falls within a range that is equal to or larger than 35% and equal to or smaller than 65% of the area of the first block 20, and the difference in the area between the two block pieces 20a, 20b is small. Thus, the ground contact pressure between the two block pieces 20a, 20b is less likely to be unequal, and both of the block pieces 20a, 20b are worn substantially equally. The same can be said for the second block 30, which is divided into the two block pieces 30a, 30b.

The difference between the area of the first block 20 and the area of the second block 30 is equal to or smaller than 15% of one of the areas. Thus, the ground contact pressure between the first block 20 and the second block 30 is less likely to be unequal, and both of the blocks 20, 30 are worn substantially equally. These effects are further increased when the difference between the area of the first block 20 and the area of the second block 30 falls within 15% of smaller one of the areas.

Each of the sipes is formed to be shallow in the bent section or the ends thereof. Thus, a decrease in rigidity of each of the blocks 20, 30 in the bent section or the ends is suppressed.

In the case where each of the first block 20 and the second block 30 has the polygonal shape when seen from the tire outer diameter side, each of these blocks has the plural sides extending in the multiple directions. Thus, the pneumatic tire has the superior traction property.

The embodiment that has been described so far is merely illustrative, and the scope of the invention is not limited thereto. Various types of modifications, replacement, elimination, and the like can be made to the embodiment that has been described so far within the scope that does not depart from the gist of the invention. For example, the above effects can be exerted even when the two-step tapered section is formed in only one of the first projected section 22 and the second projected section 32.

### DESCRIPTION OF REFERENCE NUMERALS AND SYMBOLS

E1: Ground contact end of third block
E2: Ground contact end of fourth block
R: Road surface
10: Tire circumferential groove
11: First bent groove
12: Second bent groove
13: Wall surface
20: First block
20a: Block piece
20b: Block piece
21: First cutout section
22: First projected section
23: Sipe
23a: End
23b: End
23c: Bent section
30: Second block
30a: Block piece
30b: Block piece
31: Second cutout section
32: Second projected section
33: Sipe
40: Third block
41: Recessed section
42: Sipe
44: Projection
45: Fourth block
46: Side wall
47: Corner section
48: Sipe
50: Two-step tapered section
51: First tapered surface
52: Second tapered surface
53: R surface
54: Third tapered surface
60: Two-step tapered section
61: First tapered surface
62: Second tapered surface
63: R surface
64: Third tapered surface
120: Block
122: End
124: Tapered surface
126: Groove

1. A pneumatic tire, wherein
a first block in a shape of having a projected section that extends in a tire circumferential direction and a second block in a different shape from the first block are alternately aligned in the tire circumferential direction to forma block row,
two of the block rows are formed, and
the two second blocks are arranged on both sides in a tire width direction of the projected section of the first block.

2. The pneumatic tire according to claim 1, wherein
the first block is longer than the second block in the tire width direction,
a third block and a fourth block, each of which has an end in the tire width direction, are alternately aligned in the tire circumferential direction on both sides in the tire width direction of the two block rows,
the third block is shorter than the fourth block in the tire width direction, and
the first block and the third block are aligned in the tire width direction.

3. The pneumatic tire according to claim 1, wherein
each of the first block and the second block is formed with a sipe that penetrates the respective block,
each of the blocks is divided into two block pieces by the sipe, and
an area of each of the block pieces is equal to or larger than 35% and equal to or smaller than 65% of an area of the block to which the block piece belongs.

4. The pneumatic tire according to claim 1, wherein
a difference between an area of the first block and an area of the second block falls within 15% of either one thereof.

5. The pneumatic tire according to claim 1, wherein
each of the first block and the second block is formed with a sipe that penetrates the respective block, and
the sipe is formed to be shallower in a bent section thereof or at an end of the block than another portion.
